(19) United States
(12) Patent Application Publication
(10) Pub. No.: US 2026/0317223 A1
(43) Pub. Date: Oct. 15, 2026

(54) GLASS MATERIAL, METHOD FOR PREPARING THE SAME, AND APPLICATION THEREOF IN RADIATION SHIELDING

(71) Applicant: CNBM PHOTONICS TECHNOLOGY CO., LTD., Shandong (CN)

(72) Inventors: Yu HAN, Shandong (CN); Zhenbo CAO, Shandong (CN); Meilun ZHANG, Shandong (CN); Shengyun YANG, Shandong (CN); Ke WANG, Shandong (CN); Shaohua LI, Shandong (CN); Qiao WANG, Shandong (CN); Yang ZHANG, Shandong (CN); You ZHOU, Shandong (CN); Jinsheng JIA, Shandong (CN); Sheng HONG, Shandong (CN)

(73) Assignee: CNBM PHOTONICS TECHNOLOGY CO., LTD., Shandong (CN)

(21) Appl. No.: 18/870,469

(22) PCT Filed: Dec. 15, 2023
(86) PCT No.: PCT/CN2023/139041

§ 371 Date: Nov. 29, 2024

(51) Int. Cl. C03C 4/08; C03C 3/095; G21F 1/06

(52) U.S. Cl. CPC C03C 4/08; C03C 3/095; G21F 1/06

(57) ABSTRACT

The present invention provides a glass material, a method for preparing the same, and an application thereof in a radiation shielding field. The glass material comprises or consists of in weight percentage: SiO₂ 45-60%, BaO 0.1-1%, B₂O₃ 10-20%, CeO₂ 2-5%, Al₂O₃ 1-2%, MgO 2.7-5%, Na₂O 0-20%, and K₂O 9-15%.

### TECHNICAL FIELD

The present invention relates to a special glass material, and specifically relates to a glass material, method for preparing the same, and application thereof in radiation shielding.

### BACKGROUND

Any discussion of prior art throughout the specification should not be construed as an admission that such prior art is widely known or forms part of the common general knowledge in the field.

In nuclear research, radiation shielding window is the only window through which researchers or operators can observe nuclear waste solidification, spent fuel purification, and nuclear material processing from the operating room side. It is the only means to clearly observe the entire work area in the hot cell and the operation of manipulators or mechanical arms. In some environments with severe radiation contamination, the gamma radiation dose rate difference between the hot cell and the operating room can be as high as 2×10⁷ times. When high-energy electron radiation hits the surface of objects, it can damage the crystal structure of surface materials causing defects. Meanwhile, the ionization and displacement effects produced by high-energy protons and heavy ions can cause the glass material to darken and dim, thereby reducing the transmittance of the glass material. Furthermore, in strong radiation environments, there are also alpha and beta rays present. Although alpha and beta rays have weak penetrating power, if they enter human tissues and organs, their energy will be completely absorbed by the tissues and organs, causing extreme harm to the human body. Therefore, special attention must be paid to preventing internal exposure to alpha and beta rays. Consequently, the glass closest to the hot cell side in radiation shielding windows must have good shielding performance against alpha and beta rays, good radiation resistance to high-energy rays/particles, while also possessing good processability and sealing properties, meaning high requirements for the material's comprehensive performance.

However, existing radiation-resistant glass materials often have poor comprehensive performance, such as lacking good optical transmittance or having poor radiation resistance under high-dose gamma radiation, with significant deterioration in transmittance, chemical stability, mechanical properties (such as strength and hardness), and processability after irradiation, leading to serious decline in overall material performance.

### SUMMARY

Addressing the deficiencies in existing technology, the present invention provides a glass material that combines high light transmittance, comprehensive radiation shielding capability, excellent radiation resistance, good shielding performance against alpha and beta rays, and good gamma radiation resistance, while also possessing excellent chemical and mechanical properties, as well as good processability and sealing properties, to meet the strict requirements for shielding windows in the nuclear industry. Additionally, this glass material maintains excellent transmission performance, chemical stability, and mechanical properties even after multiple exposures to high-dose gamma radiation, making it more suitable for practical applications. This material may also have broad application prospects in aerospace, nuclear medicine, and other fields.

In particular, the present invention provides the following technical features, one or more of which constitute a technical solution for the present invention.

In a first aspect of the present invention, a glass material is provided, which comprises, in weight percentage: SiO₂ 45-60%; BaO 0.1-1%; B₂O₃ 10-20%; CeO₂ 2-5%; Al₂O₃ 1-2%; MgO 2.7-5%; NaO₂ 0-20%; K₂O 9-15%.

In a preferred embodiment, the glass material of the present invention consists of, in weight percentage: SiO₂ 45-60%; BaO 0.1-1%; B₂O₃ 10-20%; CeO₂ 2-5%; Al₂O₃ 1-2%; MgO 2.7-5%; NaO₂ 0-20%; K₂O 9-15%, wherein the sum of the mass percentages of all components is 100%.

In embodiments of the present invention, SiO₂ serves as the main component of the glass material, providing a stable structural framework. When the SiO₂ content is too high, the melting point of the glass material may be excessive, increasing processing difficulty; when too low, it may lead to insufficient structural stability, reducing the mechanical strength and chemical stability of the glass material. The addition of B₂O₃ improves thermal stability and chemical stability, reduces high-temperature viscosity, and participates in the framework network together with SiO₄, enhancing network stability. However, the B₂O₃ content needs to be strictly controlled to avoid disrupting the network structure. For example, when B₂O₃ is excessive, some B₂O₃ can no longer form BO₄ and can only exist in the network as triangular BO₃, which would instead destroy the framework structure, reducing the proportion of strong, tight unified networks and lowering the chemical stability of the glass material; while if the B₂O₃ content is insufficient, the effect of improving thermal stability cannot be fully exerted. In some embodiments of the present invention, in weight percentage, the content of SiO₂ is 45-60%, and the content of B₂O₃ is 10-20%. More preferably, the content of SiO₂ is 50-60%, preferably 56-60%, more preferably 59-60%, and the content of SiO₂ can also be selected from the following: 52-60%, 59.9-60%, 45-59.9%, 45-56%, 45-52%, 52-59.9%, 52-56%, 56-59.9%. More preferably, the content of B₂O₃ is 10-18%, preferably 10-17%, and the content of B₂O₃ can also be selected from the following: 10-10.1%, 10-10.3%, 10.1-20%, 10.1-18%, 10.1-17%, 10.1-10.3%, 10.3-20%, 10.3-18%, 10.3-17%, 17-20%, 18-20%, 17-18%. Controlling the contents of SiO₂ and B₂O₃ within the above ranges, particularly within the preferred content ranges, provides a structural foundation for the glass material to achieve good thermal stability, chemical stability, and mechanical strength, while also improving the material's thermal expansion coefficient, softening temperature, and other properties. Particularly, in some embodiments of the present invention, when the content of SiO₂ is not less than 2.6 times the content of B₂O₃, the synergistic effect of SiO₂ and B₂O₃ can be better achieved.

In embodiments of the present invention, the glass material also contains NaO₂ with a mass percentage of 0-20% and K₂O with a mass percentage of 9-15%. Introducing K₂O and/or Na₂O in these proportions to SiO₂ and B₂O₃ helps form a homogeneous glass material. The oxygen atoms in K₂O and/or Na₂O can enter the unoccupied outer orbitals of B, causing the rearrangement of boron's outer electron orbitals, promoting the transformation of BO₃ (triangular boron oxygen) to BO₄ (tetrahedral boron oxygen), which leads to the conversion of boron's structure from a planar layered structure to a three-dimensional framework structure, further providing fundamental conditions for SiO₂ and B₂O₃ to merge into a homogeneous glass matrix. Meanwhile, K₂O and/or Na₂O can act as fluxing agents, accelerating the glass melting and clarification process. The mixed alkali effect of K₂O and Na₂O can reduce glass surface tension, and the incorporation of K⁺ and/or Na⁺ ions is beneficial for optimizing the glass structure, thereby enhancing the mechanical properties of the glass material. The balance of proportions between K₂O and/or Na₂O is crucial for maintaining the chemical stability and mechanical strength of the glass. Excessive content of K₂O and/or Na₂O would reduce the chemical stability and mechanical strength of the glass, while insufficient content would not effectively lower the melting point and improve processability. In some embodiments of the present invention, in weight percentage, the content of K₂O is further 9-13.5%, preferably 9.6-13.5%, more preferably 9.6-12%, and the content of K₂O can also be selected from the following: 9-13.1%, 9-12%, 9-11.3%, 9-11%, 9-10%, 9-9.6%, 9.6-15%, 9.6-13.1%, 9.6-11.3%, 9.6-11%, 9.6-10%, 10-15%, 10-13.5%, 10-13.1%, 10-12%, 10-11.3%, 10-11%. In some embodiments of the present invention, in weight percentage, the content of NaO₂ is further 0-15% or 10-20%, preferably 0-12%, more preferably 10-12% or 0; and the content of NaO₂ can also be selected from: 0-14.2%, 0-13.2%, 0-10.4%, 0-10%, 10-20%, 10-15%, 10-14.2%, 10-13.2%, 10-10.4%, 10.4-20%, 10.4-15%, 10.4-14.2%, 10.4-13.2%, 10.4-12%, 12-20%, 12-15%, 12-14.2%, 12-13.2%, 13.2-20%, 13.2-15%, 13.2-14.2%, 14.2-20%, 14.2-15%. Controlling the content of K₂O and/or Na₂O within the aforementioned ranges, particularly within the preferred content ranges, further ensures that the glass material obtains suitable melting point, good processability, mechanical properties, and chemical stability. Particularly, in some embodiments of the present invention, when the content of K₂O is not less than 0.8 times the content of Na₂O, it further promotes the synergistic effect of SiO₂ and B₂O₃, and better balances the chemical stability and mechanical strength of the glass material.

In embodiments of the present invention, the glass material also contains BaO with a mass percentage of 0.1-1%. The introduction of BaO at this content level can provide free oxygen, promote glass melting, and improve glass fiber drawing. Additionally, the introduction of BaO at this content level helps slow down the speed of radiation ions and possesses ray capture capability, which can reduce the probability of glass structure damage and enhance the radiation resistance of the glass material. However, it should be noted that while the introduction of BaO brings better radiation resistance, it also affects the chemical stability of the glass material. Particularly, when the content is too high, it significantly reduces the chemical stability of the glass material, while lower content results in insufficient radiation resistance. On this basis, the glass material of the present invention also incorporates CeO₂ with a mass percentage of 2-5%. This content of CeO₂ can effectively prevent the formation of color centers in radiation environments, improve radiation stability, and provide good ultraviolet absorption capability. Meanwhile, it helps with clarification, reduces glass defects, and particularly works synergistically with 0.1-1% BaO, helping to improve transmittance and enhance radiation resistance, achieving a good balance between transmittance and radiation resistance while avoiding the adverse effects on chemical stability brought by introduction of BaO. However, it should be noted that the content of CeO₂ should not be too high, for example, when exceeding 1%, it would significantly reduce the transmittance of the glass material. In embodiments of the present invention, a series of suitable contents for BaO and CeO2 are provided. For example, in some embodiments of the present invention, in weight percentage, the content of BaO is 0.2-1%, preferably 0.3-1%, more preferably 0.1-0.4%, further preferably 0.1-0.3% or 0.3-0.4%, and the content of BaO can also be selected from the following: 0.1-0.9%, 0.1-0.5%, 0.1-0.4%, 0.1-0.2%, 0.2-1%, 0.2-0.9%, 0.2-0.5%, 0.2-0.4%, 0.2-0.3%, 0.3-1%, 0.3-0.9%, 0.3-0.5%, 0.4-1%, 0.4-0.9%, 0.4-0.5%, 0.5-1%, 0.5-0.9%, 0.9-1%. In some embodiments of the present invention, in weight percentage, the content of CeO₂ is 2.5-5%, preferably 2.5-4% or 4-5%, and the content of CeO₂ can also be selected from the following: 2-4%, 2-3%, 2-2.7%, 2-2.6%, 2-2.5%, 2-2.3%, 2-2.1%, 2.1-5%, 2.1-4%, 2.1-3%, 2.1-2.7%, 2.1-2.6%, 2.1-2.5%, 2.1-2.3%, 2.3-5%, 2.3-4%, 2.3-3%, 2.3-2.7%, 2.3-2.6%, 2.3-2.5%, 2.5-3%, 2.5-2.7%, 2.5-2.6%, 2.6-5%, 2.6-4%, 2.6-3%, 2.6-2.7%, 2.7-5%, 2.7-4%, 2.7-3%, 3-5%, 3-4%. Controlling the contents of BaO and CeO₂ within the aforementioned ranges, particularly within the preferred content ranges, achieves a good balance between the glass material's radiation resistance and transmittance, while further stabilizing the material's chemical stability. Particularly, in some embodiments of the present invention, the content of CeO₂ should be not less than 2.7 times the content of BaO, which can better achieve the synergistic complementary effect of CeO₂ and BaO.

In embodiments of the present invention, Al₂O₃ and MgO are also introduced simultaneously. As structure-modifying oxides, they work together in the present invention to reduce the glass's crystallization tendency and thermal expansion coefficient, and improve thermal stability; meanwhile, their introduction in the present invention also serves to enhance the chemical stability and mechanical strength of the glass. However, it should be noted that the use of Al₂O₃ and MgO requires content control to avoid negative effects on glass fluidity and reduce manufacturing costs. For example, when Al₂O₃ content is excessive, it increases the viscosity of the glass liquid, making melting and clarification difficult, and instead increases crystallization tendency. For instance, when MgO content is excessive, it negatively affects glass properties, increases glass crystallization tendency, while also raising the annealing temperature and increasing manufacturing costs. Therefore, in embodiments of the present invention, the mass percentage of Al₂O₃ should be controlled at 1-2%, and the mass percentage of MgO at 2.7-5%. Meanwhile, in embodiments of the present invention, a series of suitable contents for Al₂O₃ and MgO are also provided. For example, in some embodiments of the present invention, in weight percentage, the content of Al₂O₃ is 1-1.5%, preferably 1-1.4%, more preferably 1-1.1% or 1.4-1.5%; and the content of Al₂O₃ can also be selected from the following: 1-1.2%, 1.1-2%, 1.1-1.5%, 1.1-1.4%, 1.2-2%, 1.2-1.5%, 1.2-1.4%, 1.4-2%, 1.4-1.5%, 1.5-2%. In some embodiments of the present invention, in weight percentage, the content of MgO is 2.7-4%, preferably 2.7-3.9%, more preferably 2.7-3.4% or 3.4-5%; and the content of MgO can also be selected from the following: 2.7-3%, 2.7-3.3%, 3.3-5%, 3.5-4%, 3.3-3.9%, 3.3-3.4%, 3.4-5%, 3.4-4%, 3.4-3.9%, 3.9-5%, 3.9-4%. Particularly, in some embodiments of the present invention, the content of CeO₂ should be not less than 2.7 times the content of BaO. This can better achieve the synergistic effect of Al₂O₃ and MgO.

In some embodiments of the present invention, the glass material consists of, in weight percentage, the following components: SiO₂ 45-60%, BaO 0.1-1%, B₂O₃ 10-18%, CeO₂ 2-5%, Al₂O₃ 1-1.5%, MgO 2.7-5%, NaO₂ 0-20%, K₂O 9-13.1%, wherein the sum of the mass percentages of all components is 100%.

In some embodiments of the present invention, the glass material consists of, in weight percentage, the following components: SiO₂ 45-60%, BaO 0.3-1%, B₂O₃ 10-17%, CeO₂ 2.1-5%, Al₂O₃ 1-1.5%, MgO 2.7-5%, NaO₂ 0-12%, K₂O 9-13.1%, wherein the sum of the mass percentages of all components is 100%.

In some embodiments of the present invention, the glass material consists of, in weight percentage, the following components: SiO₂ 45-60%, BaO 0.3-1%, B₂O₃ 10-17%, CeO₂ 2.7-5%, Al₂O₃ 1-1.4%, MgO 2.7-3.4%, NaO₂ 10-12%, K₂O 9.6-11%, wherein the sum of the mass percentages of all components is 100%.

In some embodiments of the present invention, the glass material consists of, in weight percentage, the following components: SiO₂ 59-60%, BaO 0.3-1%, B₂O₃ 10-17%, CeO₂ 2.7-5%, Al₂O₃ 1-1.4%, MgO 2.7-3.4%, NaO₂ 10-12%, K₂O 9.6-11%, wherein the sum of the mass percentages of all components is 100%.

The present invention prepares glass with homogeneous internal quality and stable composition by adjusting the contents of SiO₂, B₂O₃, Na₂O, and K₂O, achieving good mechanical stability. Moreover, on this basis, the present invention balances the glass's transmittance and radiation resistance by controlling BaO, CeO₂, and other components, resulting in good shielding performance against α-rays and β-rays as well as gamma radiation resistance, with excellent comprehensive shielding performance while maintaining good optical transmittance. Furthermore, by introducing and controlling the contents of Al₂O₃ and MgO, the glass's crystallization tendency and thermal expansion coefficient are reduced, improving thermal stability while further enhancing chemical stability and mechanical strength. The combination of these components also reduces glass melting viscosity, decreases glass forming difficulty, reduces surface tension, improves mechanical properties and sealing performance, facilitating processing and manufacturing. The glass material obtained through the coordinated combination of these components not only provides shielding performance against α-rays and β-rays and good gamma radiation resistance but also maintains excellent transmittance, chemical stability, and mechanical properties even after multiple exposures to high-dose gamma radiation, making it easy to process and manufacture, and more suitable for practical applications.

In a second aspect of the present invention, a method for preparing the glass material according to the first aspect is provided, which includes: mixing raw materials in proportion followed by melting, stirring, then high temperature clarification and forming to obtain the glass material.

In an embodiment of the present invention, the method includes:
S1. mixing glass components, including quartz sand, boric acid, alkali metal and/or alkaline earth metal salts in proportion, then adding clarifying agent in proportion and mixing thoroughly to obtain a mixture;
S2. melting and stirring of the mixture;
S3. stirring to clarification and forming to obtain the glass material.

In some embodiments of the present invention, the alkali metal and/or the alkaline earth metal salts are carbonates and/or nitrates.

In some embodiments of the present invention, a temperature of melting is 1360-1450° C., with a melting time of 9-30 h.

In some embodiments of the present invention, a stirring speed is 10-40 r/min, with a stirring time of 10-14 h. The glass melt requires a certain degree of homogeneity before forming, therefore the glass melt needs to be stirred at a specific rotation speed for a period before forming to improve its homogeneity and clarity. When the homogeneity of the melt is low, the melt tends to exhibit layering or agglomeration phenomena, causing difficulties in glass melting, clarification, and homogenization, and in severe cases, may even result in streak or stone defects. Low clarity of the melt will lead to bubbles in the formed glass, reducing glass quality.

In some embodiments of the present invention, a temperature of forming is 1060-1150° C., with a forming time of 5-25 min. Rapid glass forming prevents the generation of secondary bubbles and impurities.

In a third aspect of the present invention, an optical element is provided, which contains or is made from the glass material described in the first aspect.

In some embodiments of the present invention, the optical element can shield γ-rays, α-rays, and β-rays.

In a fourth aspect of the present invention, a radiation shielding material is provided, which contains or is made from the glass material described in the first aspect.

In some embodiments of the present invention, the radiation shielding material is used for shielding γ-rays, α-rays, and β-rays.

In some embodiments of the present invention, the radiation shielding material is a radiation shielding window material.

In a fourth aspect of the present invention, applications of the glass material described in the first aspect, or the optical element described in the third aspect, or the radiation shielding material described in the fourth aspect in optical fields or radiation shielding fields are provided.

In some embodiments of the present invention, the radiation shielding field or optical field is selected from nuclear industry field, nuclear medicine field, and space exploration field.

In some embodiments of the present invention, the application is use as radiation shielding window material.

The specific technical features described in the above embodiments of the present invention can be combined in any suitable manner without contradiction. To avoid unnecessary repetition, the present invention will not further explain various possible combinations.

Unless otherwise specified, the numerical ranges mentioned in the present invention include all values within these ranges, and include range values composed of any two values within these ranges. For example, 0.3-1% includes all values between 0.3-1%, and includes range values (0.31-0.99%) composed of any two values within this range (for example: 0.31%, 0.99%); different values of the same parameter appearing in all embodiments of the present invention can be combined arbitrarily to form range values.

Through the above one or more technical means, the following beneficial effects can be achieved:

The glass material provided by the present invention possesses high transmittance, high chemical stability, good shielding performance against α-rays and β-rays, resistance to high-energy radiation, and good mechanical properties. Before irradiation, the glass material provided by the present invention has a maximum transmittance≥90.3% and minimum transmittance≥70.10% in the range of 400-800 nm; after exposure to high-dose gamma radiation of 1×10⁶ Gy, it maintains a maximum transmittance≥88.1% and minimum transmittance≥53.8% in the range of 400-800 nm. The glass shows minimal changes in transmittance and mechanical strength before and after irradiation, with almost no change in chemical stability, indicating its good radiation resistance. Notably, the glass can maintain good transmittance, chemical stability, and mechanical strength even after multiple irradiations. For example, in an embodiment of the present invention, after three exposures to high-dose gamma radiation of 1×10⁶ Gy, the glass still maintains transmittance above 87% in the 400-800 nm range.

The glass material provided by the present invention has suitable melting temperature (1360-1450° C.), good devitrification resistance, good mechanical properties, and is easy to form and process.

Existing glass has low transmittance over a wide wavelength range, and after exposure to high-intensity high-energy radiation, glass materials tend to form color centers, affecting their transmittance. The present invention prepares high-transmittance, high chemical stability, radiation-resistant glass by selecting and adjusting the comprehensive ratio of components such as BaO, CeO₂, Al₂O₃, and MgO, maintaining high transmittance even after multiple exposures to high-dose gamma radiation.

### BRIEF DESCRIPTION OF THE DRAWINGS

The accompanying drawings forming part of this invention are provided for further understanding of the invention. The exemplary embodiments and their descriptions are used to explain the invention and do not constitute improper limitations of the invention. The following detailed description of embodiments of the invention is provided in conjunction with the drawings, wherein:

FIG. 1 is a schematic diagram of an optical glass turbidity measurement device for testing glass moisture resistance stability, wherein: 1 is a light source; 2 is a parallel light tube; 3 is a sample; 4 is an integrating sphere; 5 is a photoelectric detector; 6 is a light trap; 7 is a standard white board.

FIG. 2 is a comparison curve diagram of transmittance in the range of 400-800 nm before and after 1×10⁶ Gy gamma ray irradiation between a glass product of the present invention and a comparative glass product.

FIG. 3 is a comparison diagram of maximum transmittance in the range of 400-800 nm before and after each irradiation for a glass product of the present invention and a comparative glass product after three cycles of gamma ray irradiation (with an irradiation dose of 1×10⁶ Gy for each cycle).

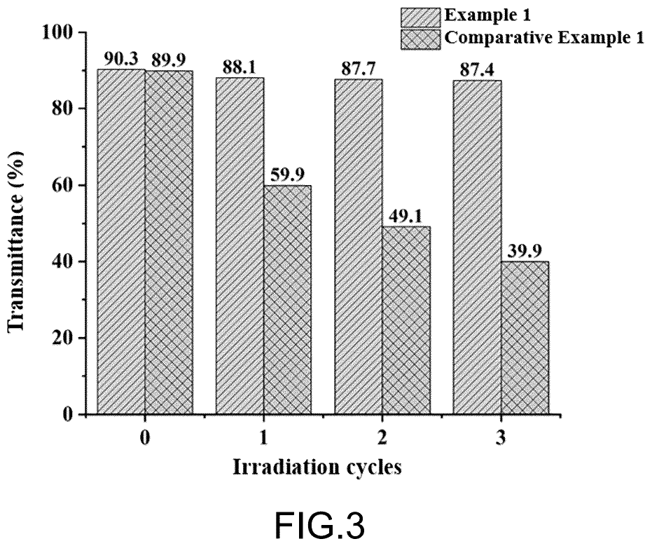

### DESCRIPTION OF THE PREFERRED EMBODIMENTS

The invention will be further elaborated in combination with specific examples below. It should be understood that these embodiments are intended to illustrate the present application only and not to limit the scope of the present application. Experimental methods for which specific conditions are not indicated in the following embodiments generally follow conventional conditions or follow the conditions recommended by the manufacturer.

Unless otherwise defined, all professional and scientific terms used in the text have the same meaning as those familiar to those skilled in the art. Reagents or raw materials used in the present application are available through conventional means. Unless otherwise specified, reagents or raw materials used in the present application are used in a conventional manner in the field or in accordance with product specifications. In addition, any methods and materials similar or equivalent to those described herein can be used in the methods of the present disclosure. The preferred embodiments described herein are exemplary only. In the present invention, weight percentage and mass percentage represent the same meaning, indicating the proportion of a component in a mixture, which is calculated by dividing the mass of that component by the total mass of the mixture and multiplying by 100%, expressed as wt %.

The performance parameters in the following examples were obtained according to the following measurement methods:

The coefficient of thermal expansion (CTE) of glass samples was tested using a DIL 402 dilatometer manufactured by NETZSCH (Germany). For sample preparation, the glass samples were ground and polished into cylindrical glass rods of Φ6×50 mm with parallel end faces. The heating rate was set to 5° C./min with a data acquisition period of 20 ms. The data was plotted as temperature versus linear expansion curve, and the glass transition temperature and expansion softening temperature were obtained using the tangent method. (GB/T 7962.16-2010)

The transmittance test was performed using an UV-Vis-IR spectrophotometer.

Acid resistance stability test: solutions with pH values of 2.9, 4.6, and 6.0 were used as test media. After the polished glass sample surface was eroded by the test media, the time for the appearance of purple-blue interference color, miscellaneous colors, or delamination on the glass surface was observed under incandescent light. The acid resistance stability of colorless optical glass was classified in descending order according to the duration. (GB/T 7962.14-2010)

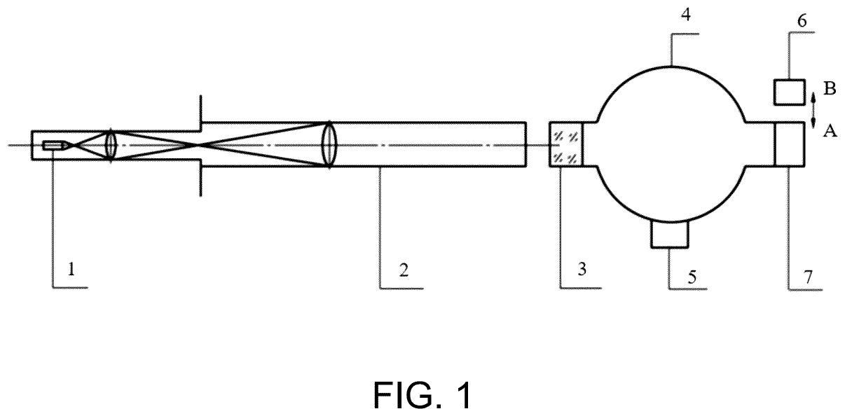

Moisture resistance stability test: using the device shown in FIG. 1, the turbidity values H₀ and H₁ of both test samples and standard samples (BaK7 glass and ZK9 glass) were measured before and after erosion. The turbidity value H was calculated by H=H₁−H₀. The moisture resistance stability grade of optical glass was determined by comparing with standard sample turbidity values using reference tables. (GB/T 7962.15-2010)

Glass bending strength test: the bending strength of the sample was calculated using the following formula by measuring the width b and thickness d at the middle of the sample, the span L between two sample supports, and the maximum load P at sample fracture (GB/T 37781-2019):

$${σ}_{b} = \frac{3 PL}{2 {bd}^{2}}$$

wherein σ_{b} is the bending strength of the sample in megapascals (MPa); P is the maximum load at sample fracture in newtons (N); b is the sample width in millimeters (mm); d is the sample thickness in millimeters (mm).

Glass hardness test: using a four-sided pyramid diamond indenter with symmetric edge angles of 172°30′ and 130°, a certain load was applied vertically on the sample surface. After maintaining for a specified time, the load was removed. The length of the indentation diagonal was observed and measured using a microscope, converted to the projected area of the indentation, and the Knoop hardness H_{K} was calculated using the following formula (GB/T 7962.18-2010):

$${H}_{K} = 1.4229 \frac{F}{{d}^{2}}$$

wherein F is the applied load in newtons (N); d is the length of the indentation diagonal in millimeters (mm); H_{K} is the Knoop hardness in 10⁷ pascals (10⁷ Pa).

The present invention will be further illustrated in combination with specific examples below.

### Example 1

The components and their weight percentages of the glass material in this example are shown in Table 1, and the physical properties are shown in Table 2.

The preparation method is as follows: using quartz sand, boric acid, aluminum hydroxide, potassium carbonate, sodium carbonate, barium oxide, aluminum oxide, and magnesium oxide as raw materials, with addition of CeO₂ as a clarifying agent accounting for 5.0% by weight of the glass, after thorough mixing, the mixture was melted at high temperature of 1360° C. for 9 h, mechanical stirring was performed at 10 r/min for 10 h, clarified at high temperature with auxiliary stirring, and formed by drawing or casting at 1060° C. (forming time of 5 min) into glass blanks.

### Example 2

The components and their weight percentages of the glass material in this example are shown in Table 1, and the physical properties are shown in Table 2.

In the preparation method, CeO₂ was used as the clarifying agent accounting for 3.0% by weight of the glass; the melting temperature was 1400° C. with a melting time of 17 h; mechanical stirring was performed at 25 r/min for 13 h; the forming temperature was 1100° C. with a forming time of 15 min. Other preparation steps and parameters were the same as those in Example 1.

### Example 3

The components and their weight percentages of the glass material in this example are shown in Table 1, and the physical properties are shown in Table 2.

In the preparation method, CeO₂ was used as the clarifying agent accounting for 2.3% by weight of the glass; the melting temperature was 1450° C. with a melting time of 30 h; mechanical stirring was performed at 40 r/min for 14 h; the forming temperature was 1150° C. with a forming time of 25 min. Other preparation steps and parameters were the same as those in Example 1.

### Example 4

The components and their weight percentages of the glass material in this example are shown in Table 1, and the physical properties are shown in Table 2.

In the preparation method, CeO₂ was used as the clarifying agent accounting for 2.0% by weight of the glass; the melting temperature was 1390° C. with a melting time of 20 h; mechanical stirring was performed at 20 r/min for 12 h; the forming temperature was 1080° C. with a forming time of 15 min. Other preparation steps and parameters were the same as those in Example 1.

### Example 5

The components and their weight percentages of the glass material in this example are shown in Table 1, and the physical properties are shown in Table 2.

In the preparation method, CeO₂ was used as the clarifying agent accounting for 2.1% by weight of the glass; the melting temperature was 1420° C. with a melting time of 25 h; mechanical stirring was performed at 35 r/min for 14 h; the forming temperature was 1100° C. with a forming time of 25 min. Other preparation steps and parameters were the same as those in Example 1.

### Example 6

The components and their weight percentages of the glass material in this example are shown in Table 1, and the physical properties are shown in Table 2.

In the preparation method, CeO₂ was used as the clarifying agent accounting for 3.0% by weight of the glass; the melting temperature was 1410° C. with a melting time of 17 h; mechanical stirring was performed at 25 r/min for 13 h; the forming temperature was 1100° C. with a forming time of 20 min. Other preparation steps and parameters were the same as those in Example 1.

### Example 7

The components and their weight percentages of the glass material in this example are shown in Table 1, and the physical properties are shown in Table 2. The raw material requirements and preparation method were the same as in Example 1.

### Example 8

The components and their weight percentages of the glass material in this example are shown in Table 1, and the physical properties are shown in Table 2. The raw material requirements and preparation method were the same as in Example 1.

### Example 9

The components and their weight percentages of the glass material in this example are shown in Table 1, and the physical properties are shown in Table 2. In the preparation method, CeO₂ was used as the clarifying agent accounting for 2.6% by weight of the glass. Other preparation steps and parameters were the same as those in Example 1.

### Comparative Examples 1-8

The components and their weight percentages of glass in Comparative Examples 1-8 are shown in Table 3, and their physical properties are shown in Table 4.

The preparation steps and parameters for glass in Comparative Examples 1-8 were the same as those in Example 1.

TABLE 1
Components and Contents of Glass Materials
in Examples 1-9 of the Present Invention

| Compo- | | | | | | | | | |
|---|---|---|---|---|---|---|---|---|---|
| nents | Example No. | | | | | | | | |
| (wt %) | 1 | 2 | 3 | 4 | 5 | 6 | 7 | 8 | 9 |
| SiO₂ | 60 | 56 | 52 | 45 | 52 | 60 | 50 | 60 | 60 |
| B₂O₃ | 10 | 10.1 | 10.3 | 18 | 20 | 17 | 20 | 10 | 10 |
| Al₂O₃ | 1 | 1.2 | 2 | 1 | 1 | 1.5 | 1 | 1 | 1.5 |
| BaO | 0.3 | 0.2 | 0.9 | 0.1 | 0.5 | 0.4 | 0.3 | 0.3 | 1 |
| K₂O | 11 | 11.3 | 15 | 10 | 10 | 13.1 | 11 | 9 | 11 |
| Na₂O | 10 | 13.2 | 14.2 | 20 | 10.4 | — | 10 | 12 | 10 |
| MgO | 2.7 | 5 | 3.3 | 3.9 | 4 | 5 | 2.7 | 2.7 | 3.9 |
| CeO₂ | 5 | 3 | 2.3 | 2 | 2.1 | 3 | 5 | 5 | 2.6 |
| Total | 100 | 100 | 100 | 100 | 100 | 100 | 100 | 100 | 100 |
| content | | | | | | | | | |

TABLE 2
Physical Properties of Glass Materials in Examples 1-9 of the Present Invention

| | | Example No. | | | | | | | | |
|---|---|---|---|---|---|---|---|---|---|---|
| Test Results | | 1 | 2 | 3 | 4 | 5 | 6 | 7 | 8 | 9 |
| α_{30-300° C.} | | 85.4 | 91.6 | 92.5 | 91.9 | 90.7 | 91.3 | 91.4 | 85.9 | 86.1 |
| (×10⁻⁷/° C.) | | | | | | | | | | |
| Ts | | 711 | 708 | 704 | 703 | 707 | 709 | 705 | 710 | 709 |
| (10^{7.6} dPa · s/° C.) | | | | | | | | | | |
| Maximum Optical | Before Irradiation | 90.30% | 91.00% | 91.50% | 91.90% | 91.20% | 91.20% | 90.40% | 90.20% | 91.50% |
| Transmittance | After Irradiation | 88.10% | 85.50% | 85.10% | 84.70% | 84.40% | 85.10% | 84.70% | 85.80% | 84.80% |
| (400-800 nm) | Rate of Change | 2.44% | 6.04% | 6.99% | 7.83% | 7.46% | 6.69% | 6.31% | 4.88% | 7.32% |
| Minimum Optical | Before Irradiation | 70.10% | 71.20% | 70.90% | 70.50% | 70.30% | 71.60% | 70.40% | 70.30% | 70.20% |
| Transmittance | After Irradiation | 53.80% | 54.50% | 54.60% | 55.80% | 54.90% | 54.90% | 53.50% | 53.70% | 53.20% |
| (400-800 nm) | Rate of Change | 23.25% | 23.46% | 22.99% | 20.85% | 21.91% | 23.32% | 24.01% | 23.61% | 24.22% |
| Acid Resistance Grade Before Irradiation | | Grade I | Grade I | Grade I | Grade I | Grade I | Grade I | Grade I | Grade I | Grade I |
| Acid Resistance Grade After Irradiation | | Grade I | Grade I | Grade I | Grade I | Grade I | Grade I | Grade I | Grade I | Grade I |
| Moisture Resistance Grade | | Grade I | Grade I | Grade I | Grade I | Grade I | Grade I | Grade I | Grade I | Grade I |
| Before Irradiation | | | | | | | | | | |
| Moisture Resistance Grade | | Grade I | Grade I | Grade I | Grade I | Grade I | Grade I | Grade I | Grade I | Grade I |
| After Irradiation | | | | | | | | | | |
| Bending | Before Irradiation | 156 | 152 | 151 | 152 | 152 | 153 | 153 | 154 | 155 |
| Strength (MPa) | After Irradiation | 154 | 148 | 146 | 147 | 148 | 147 | 149 | 151 | 152 |
| | Rate of Change | 1.28% | 2.63% | 3.31% | 3.29% | 2.63% | 3.92% | 2.61% | 1.95% | 1.94% |
| Knoop Hardness | Before Irradiation | 507 | 502 | 501 | 500 | 501 | 503 | 502 | 509 | 507 |
| (Kgf/mm²) | After Irradiation | 504 | 500 | 496 | 489 | 492 | 502 | 491 | 503 | 502 |
| | Rate of Change | 0.59% | 0.40% | 1.00% | 2.20% | 1.80% | 0.20% | 2.19% | 1.18% | 0.99% |

| | | | | | | | | | |
|---|---|---|---|---|---|---|---|---|---|
| α-Ray Shielding Rate | 99.97% | 99.93% | 99.92% | 99.93% | 99.91% | 99.93% | 99.92% | 99.93% | 99.95% |
| β-Ray Shielding Rate | 99.96% | 99.96% | 99.95% | 99.95% | 99.93% | 99.94% | 99.91% | 99.93% | 99.92% |

TABLE 3
Composition and Content of Glass Materials
in Comparative Examples 1-8

| Components | Comparative Example No. | | | | | | | |
|---|---|---|---|---|---|---|---|---|
| (wt %) | 1 | 2 | 3 | 4 | 5 | 6 | 7 | 8 |
| SiO₂ | 72 | 41.2 | 36.3 | 67.9 | 60 | 60 | 60 | 60 |
| B₂O₃ | 8 | 12 | 21 | 9.3 | 10 | 12.7 | 10.3 | 10 |
| Al₂O₃ | 0.5 | 1.4 | 3 | — | 2.5 | 1 | 1 | 1 |
| BaO | 1.5 | 5 | 3 | 1.2 | 0.3 | 0.3 | — | 0.3 |
| K₂O | 7 | 15.2 | 11 | 10.3 | 11 | 11 | 11 | 11 |
| Na₂O | 8 | 20.2 | 15 | 9.5 | 10 | 10 | 10 | 10 |
| MgO | 2 | 2 | 5.1 | — | 2.7 | 0 | 2.7 | 2.7 |
| CeO₂ | 1 | 3 | 5.6 | 1.8 | 3.5 | 5 | 5 | — |
| As₂O₃ | — | — | — | — | — | — | — | 5 |
| Total content | 100 | 100 | 100 | 100 | 100 | 100 | 100 | 100 |

TABLE 4
Physical Properties of Glass Materials in Comparative Examples 1-8

| | | Comparative Example No. | | | | | | | |
|---|---|---|---|---|---|---|---|---|---|
| Test Results | | 1 | 2 | 3 | 4 | 5 | 6 | 7 | 8 |
| α_{30-300° C.} (×10⁻⁷/° C.) | | 84.9 | 93.7 | 94.6 | 83.9 | 84.3 | 85.1 | 84.2 | 84.4 |
| Ts (10^{7.6} dPa · s/° C.) | | 713 | 689 | 681 | 710 | 711 | 712 | 712 | 713 |
| Maximum Optical | Before Irradiation | 89.90% | 91.10% | 87.70% | 90.80% | 90.60% | 90.40% | 90.50% | 90.70% |
| Transmittance | After Irradiation | 59.90% | 84.70% | 86.70% | 78.90% | 77.40% | 78.10% | 76.80% | 56.60% |
| (400-800 nm) | Rate of Change | 33.37% | 7.03% | 1.14% | 13.11% | 14.57% | 13.61% | 15.14% | 37.60% |
| Minimum Optical | Before Irradiation | 69.90% | 68.80% | 64.20% | 67.20% | 68.10% | 67.80% | 68.60% | 69.10% |
| Transmittance | After Irradiation | 33.20% | 57.80% | 61.70% | 43.70% | 43.90% | 44.50% | 43.20% | 33.10% |
| (400-800 nm) | Rate of Change | 52.50% | 15.99% | 3.89% | 34.97% | 35.54% | 34.37% | 37.03% | 52.10% |
| Acid Resistance Grade Before Irradiation | | Grade I | Grade I | Grade I | Grade I | Grade I | Grade I | Grade I | Grade I |
| Acid Resistance Grade After Irradiation | | Grade II | Grade II | Grade III | Grade II | Grade II | Grade III | Grade II | Grade II |
| Moisture Resistance Grade Before Irradiation | | Grade I | Grade I | Grade I | Grade I | Grade I | Grade I | Grade I | Grade I |
| Moisture Resistance Grade After Irradiation | | Grade II | Grade II | Grade III | Grade II | Grade II | Grade III | Grade III | Grade II |
| Bending Strength (MPa) | Before Irradiation | 153 | 149 | 147 | 150 | 148 | 149 | 149 | 151 |
| | After Irradiation | 103 | 110 | 109 | 107 | 105 | 104 | 106 | 109 |
| | Rate of Change | 32.68% | 26.17% | 25.85% | 28.67% | 29.05% | 30.20% | 28.86% | 27.81% |
| Knoop Hardness (Kgf/mm²) | Before Irradiation | 503 | 493 | 485 | 500 | 501 | 500 | 504 | 502 |
| | After Irradiation | 388 | 259 | 206 | 434 | 398 | 396 | 401 | 409 |
| | Rate of Change | 22.86% | 47.46% | 57.53% | 13.20% | 20.56% | 20.80% | 20.44% | 18.53% |
| α-Ray Shielding Rate | 97.10% | 96.91% | 97.35% | 97.02% | 97.22% | 96.65% | 96.94% | 97.04% | 96.24% |
| β-Ray Shielding Rate | 96.96% | 97.34% | 97.41% | 96.93% | 96.81% | 96.43% | 96.42% | 96.12% | 97.01% |

In Tables 2 and 4, Ts represents the softening point, which is the temperature at which the glass viscosity reaches 10^{7.6} dPa·s; α_{30-300° C.} represents the coefficient of thermal expansion measured in the range of 30-300° C.; the irradiation refers to gamma-ray irradiation with a dose of 1×10⁶ Gy.

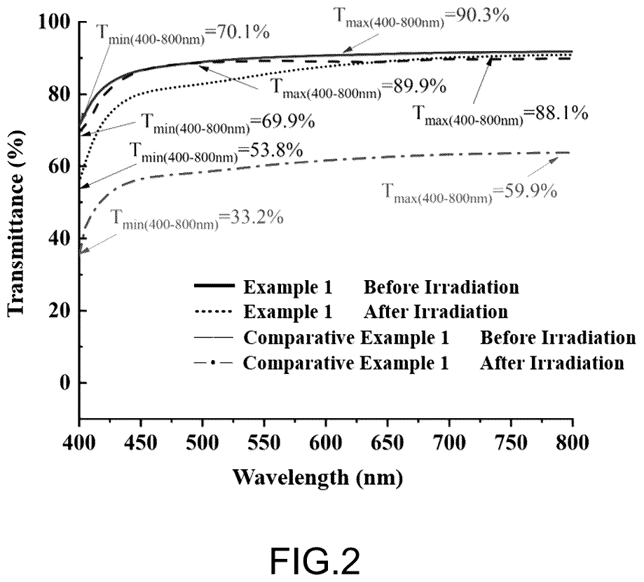

Examples 1-9 achieved better optical transmittance and radiation resistance through rational addition of corresponding components and adjustment of component proportions in raw materials. As shown in Table 2, the optical transmittance of glass obtained in Examples 1-9 of the present invention is as follows: before irradiation, in the range of 400-800 nm, the maximum transmittance is ≥90.2% and the minimum transmittance is ≥70.10%. After one exposure to 1×10⁶ Gy irradiation, in the range of 400-800 nm, the maximum transmittance is ≥84.4% and the minimum transmittance is ≥53.2%. Notably, the glass material of the present invention maintains good transmittance, chemical stability, and mechanical properties even after multiple irradiations. For example, after three gamma-ray irradiations, the glass in Example 1 still maintains a maximum transmittance above 87% in the 400-800 nm range (see FIG. 1 and FIG. 2). The glass obtained in Examples 1-9 shows superior transmittance, chemical stability, and radiation resistance compared to those in the comparative examples, while also possessing good mechanical properties and being easy to process and manufacture.

As described above, the high-transmittance, high chemical stability, and high-energy radiation-resistant glass provided in Examples 1-9 of the present invention possesses excellent optical transmittance, chemical stability, and good radiation resistance. The specific technical features described in the above embodiments of the present invention can be combined in any suitable manner without contradiction. To avoid unnecessary repetition, the present invention will not further explain various possible combinations.

The glass material of the present invention has high optical transmittance, good chemical stability, and excellent radiation resistance, with good processability and sealing performance, and good comprehensive properties. It can serve as the main material for radiation shielding windows and can also be applied in aerospace, medical, and other high-energy radiation environments, showing broad application prospects.

The aforementioned descriptions are only preferred embodiments of the present application and are not intended to limit the scope of the present application. Although the aforementioned embodiments have been described in detail, those skilled in the art can still modify the technical solutions described in the embodiments or replace some technical features with equivalent alternatives. Any modifications, equivalent replacements, improvements, and the like made within the spirit and principles of the present application should be included within the scope of the present application's protection.

1. A glass material, comprising, in weight percentage: SiO₂ 45-60%, BaO 0.1-1%, B₂O₃ 10-20%, CeO₂ 2-5%, Al₂O₃ 1-2%, MgO 2.7-5%, Na₂O 0-20%, and K₂O 9-15%.

2. The glass material according to claim 1, wherein in weight percentage, SiO₂ is 50-60%.

3. The glass material according to claim 1, in weight percentage, consisting of: SiO₂ 45-60%, BaO 0.1-1%, B₂O₃ 10-18%, CeO₂ 2-5%; Al₂O₃ 1-1.5%, MgO 2.7-5%, NaO₂ 0-20%, and K₂O 9-13.1%, with a total of 100%.

4. The glass material according to claim 1, wherein in weight percentage, an amount of SiO₂ is not less than 2.6 times an amount of B₂O₃;
wherein in weight percentage, an amount of K₂O is not less than 0.8 times an amount of Na₂O; and
wherein in weight percentage, an amount of CeO₂ is not less than 2.7 times an amount of BaO.

5. A method for preparing the glass material according to claim 1, comprising: mixing raw materials in proportion, followed by melting, stirring, then clarification and forming to obtain the glass material.

6. The method according to claim 5, wherein the method comprises:
mixing the raw materials including quartz sand, boric acid, alkali metal and/or alkaline earth metal salts in proportion, followed by adding a clarifying agent in proportion and mixing thoroughly to obtain a mixture;
melting and stirring of the mixture;
stirring to clarification and forming to obtain the glass material.

7. The method according to claim 6, wherein the alkali metal and/or the alkaline earth metal salts are carbonates and/or nitrates;
a melting temperature is 1360-1450° C. with a melting time of 9-30 h;
a stirring speed is 10-40 r/min with a stirring time of 10-14 h;
a forming temperature is 1060-1150° C. with a forming time of 5-25 min.

8. An optical element, comprising the glass material according to claim 1,
wherein the optical element is capable of shielding γ-rays, α-rays and β-rays.

9. A radiation shielding material, comprising the glass material according to claim 1,
wherein the radiation shielding material is configured to shield γ-rays, α-rays and β-rays.

10. A method of shielding radiation, comprising:
providing the glass material according to claim 1,
installing the glass material as a radiation shielding window in equipment or facilities requiring protection from γ-rays, α-rays and β-rays; and
shielding γ-rays, α-rays and β-rays through the radiation shielding window to protect the equipment or facilities,
wherein the equipment or facilities are used in at least one field selected from the group consisting of nuclear industry, nuclear medicine, and space exploration.

11. The glass material according to claim 1, wherein in weight percentage, BaO is 0.2-10% or 0.1-0.4%.

12. The glass material according to claim 1, wherein in weight percentage, B₂O₃ is 10-18%.

13. The glass material according to claim 1, wherein in weight percentage, CeO₂ is 2.5-5%.

14. The glass material according to claim 1, wherein in weight percentage, Al₂O₃ is 1-1.5%.

15. The glass material according to claim 1, wherein in weight percentage, MgO is 2.7-4%.

16. The glass material according to claim 1, wherein in weight percentage, Na₂O is 0-15% or 10-20%.

17. The glass material according to claim 1, wherein in weight percentage, K₂O is 9-13.5%.

18. The glass material according to claim 1, wherein in weight percentage, consisting of: SiO₂ 45-60%, BaO 0.3-1%, B₂O₃ 10-17%, CeO₂ 2.1-5%, Al₂O₃ 1-1.5%, MgO 2.7-5%, Na₂O 0-12%, K₂O 9-13.1%, with a total of 100%.

19. The glass material according to claim 1, wherein in weight percentage, consisting of: SiO₂ 45-60%, BaO 0.3-1%, B₂O₃ 10-17%, CeO₂ 2.7-5%, Al₂O₃ 1-1.4%, MgO 2.7-3.4%, Na₂O 10-12%, and K₂O 9.6%-110%, with a total of 100%.

20. The glass material according to claim 1, wherein in weight percentage, consisting of: SiO₂ 59-60%, BaO 0.3-1%, B₂O₃ 10-17%, CeO₂ 2.7-5%, Al₂O₃ 1-1.4%, MgO 2.7-3.4%, Na₂O 10-12%, and K₂O 9.6%-11%, with a total of 100%.
